(19) United States
(12) Patent Application Publication
(10) Pub. No.: US 2013/0234494 A1
(43) Pub. Date: Sep. 12, 2013

(54) Sensors on a Degradation Platform

(71) Applicants: David R. Hall, Provo, UT (US); Ronald B. Crockett, Payson, UT (US); Jeff Jepson, Spanish Fork, UT (US); David Wahlquist, Spanish Fork, UT (US)

(72) Inventors: David R. Hall, Provo, UT (US); Ronald B. Crockett, Payson, UT (US); Jeff Jepson, Spanish Fork, UT (US); David Wahlquist, Spanish Fork, UT (US)

(21) Appl. No.: 13/414,634

(22) Filed: Mar. 7, 2012

(51) Int. Cl. B23Q 17/09

(52) U.S. Cl. 299/29

(57) ABSTRACT

A degradation assembly, comprising a platform comprising a surface. A plurality of picks each comprising a hard tip and a shank may be mounted on the surface. A plurality of sensors may also be disposed within the platform such that they can measure impacts on at least one of the picks. The sensors may be in communication with a processor. The degradation assembly may be capable of detecting and determining the location of a selected pick measuring impacts on at least one pick with at least one sensor, detecting a variation on the at least one pick with the at least one sensor, and determining a location of the at least one pick with more than one of the sensors.

### BACKGROUND OF THE INVENTION

The present invention relates to degradation operations and especially sensors for degradation operations. Degradation operations may include mining, trenching, and road milling. It is known to use sensors in degradation operations to detect certain conditions of a surface, e.g. man-hole covers for road milling operations. For example, U.S. Pat. No. 7,077,601 to Lloyd, which is herein incorporated by reference for all that it contains, discloses a series of metal detectors to detect iron utility structures in an asphalt surface.

It is also known in the art to use sensors to detect forces acting on a milling drum. For example, U.S. Pat. Pub. No. 2011/0193397 to Menzenbach et al., which is herein incorporated by reference for all that it contains, discloses a construction machine wherein a parameter is sensed corresponding to a reaction force acting on a milling drum.

Sensors may also be used to detect wear conditions on a milling roller. For example, U.S. Pat. No. 7,905,682 to Holl et al., which is herein incorporated by reference for all that it contains, discloses a machine chassis supported by a running gear, wherein a drive motor is assigned to the running gear, and a signal pickup unit detects the power consumption of the drive motor which relates to changed wear conditions of the milling roller. Holl et al. also discloses a machine chassis that can be height-adjusted by an adjustment device wherein forces occurring during milling may be indirectly detected by detecting fluid pressure in the adjustment device.

Despite the advancements as shown in the prior art, it is believed that there is still a need to develop better means to determine and/or detect worn, damaged or malfunctioning picks.

### BRIEF SUMMARY OF THE INVENTION

A degradation assembly may comprise a platform with a surface, a plurality of picks each with a hard tip opposite a shank mounted on the surface, and a plurality of sensors disposed within the platform such that they can measure impacts on the picks. Each of the plurality of sensors may correspond with one of the plurality of picks.

The plurality of sensors may be disposed in at least one circular array. The plurality of sensors may also be disposed substantially parallel to the plurality of picks. The sensors may be disposed in a cavity on an external surface of the platform or on an internal surface. The sensors may also be disposed inward of either surface or inward of one of the picks.

The sensors may be strain gauges, accelerometers, or acoustic sensors. If the sensors are strain gauges they may be uniaxial strain gauges or triaxial rosettes.

The platform may be a drum, a chain, a blade, or a drill bit. If the platform is a drum the sensors may be disposed around a perimeter of the drum.

Each of the plurality of sensors may comprise a unique identifier signal and be in communication with a processor. The processor may be in communication with a visual interface. The processor may be disposed within the platform and store data received from the plurality of sensors. The sensors may also comprise a wireless communication device for communication with the processor.

A selected pick may be detected and its location determined by measuring impacts on a plurality of picks with a plurality of sensors, detecting a variation on at least one of the picks with the at least one of the sensors and then determining a location of the selected pick with more than one of the sensors. This may be accomplished by detecting the variation by measuring a first reading by one sensor and determining the location by measuring dissimilar readings by adjacent sensors. This may also be accomplished by measuring three readings by three sensors, calculating three distances from each of the three sensors based on magnitudes of the three readings and finding the union of the three distances. This may alternatively be accomplished by forming at least two triangles and determining the location of the selected pick by the union of the at least two triangles.

### BRIEF DESCRIPTION OF THE DRAWINGS

FIG. 1 is a partially cut-away view of an embodiment of a degradation platform on a road milling machine.

FIG. 2 is a cross-sectional view of an embodiment of a degradation platform.

FIG. 3a is a cross-sectional view of an embodiment of a pick and a sensor in compression.

FIG. 3b is a cross-sectional view of an embodiment of a pick and a sensor in tension.

FIG. 4 is an orthogonal view of an embodiment of a degradation platform with sensors disposed in circular arrays.

FIG. 5 is a perspective view of an embodiment of a processor displaying a signal comprising a process of trilateration.

FIG. 6 is a perspective view of another embodiment of a processor displaying a signal comprising two triangles.

FIG. 7 is a cross-sectional view of an embodiment of a degradation platform with a plurality of cavities housing sensors.

FIG. 8 is a cross-sectional view of an embodiment of a degradation platform with a cavity housing a processor.

FIG. 9 is an orthogonal view of an embodiment of a degradation platform with sensors disposed in a configuration parallel to a configuration of the plurality of picks.

### DETAILED DESCRIPTION OF THE INVENTION AND THE PREFERRED EMBODIMENT

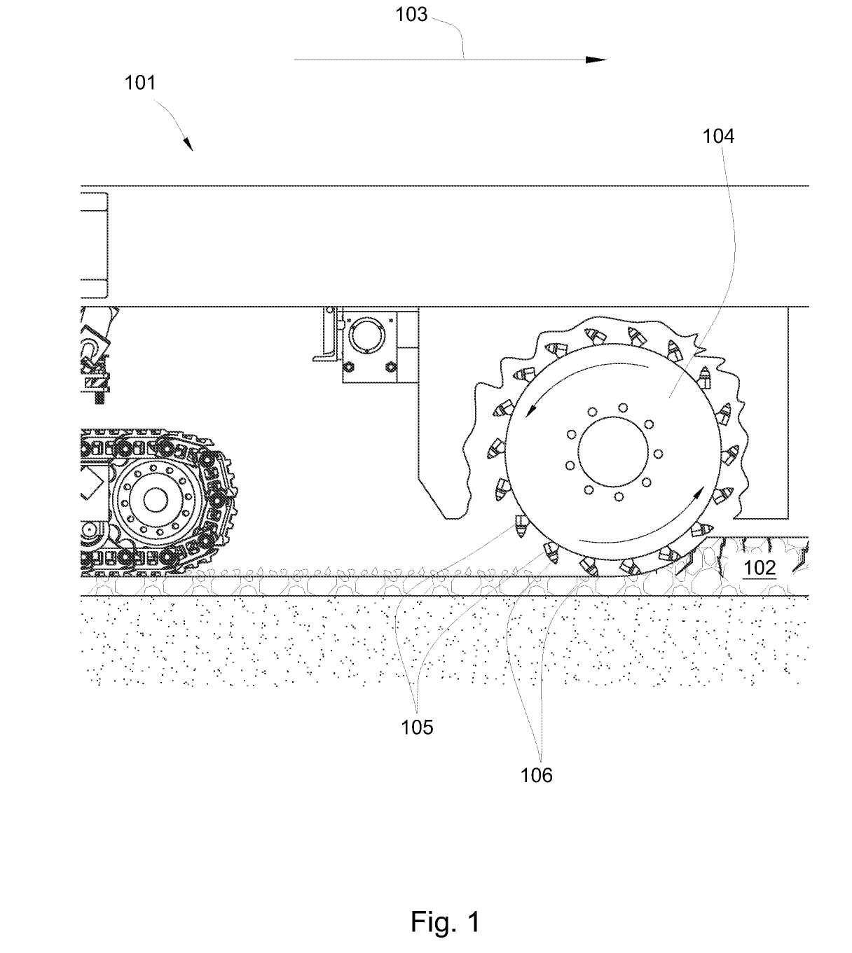

Referring now to the figures, FIG. 1 discloses an embodiment of a road milling machine 101. The road milling machine 101 also known as a cold planer, may be used to degrade a natural or man-made formation 102 such as pavement, concrete or asphalt prior to placement of a new layer. The arrow 103 shows the machine's direction of travel.

The road milling machine 101 may comprise a degradation platform; in the present embodiment the degradation platform is a degradation drum 104. The degradation drum 104 may comprise a plurality of blocks 105 secured to its outer surface. A plurality of picks 106 may be secured to the degradation drum 104 within the plurality of blocks 105. During normal operation, the degradation drum 104 may be configured to rotate causing the picks 106 to engage and degrade the formation 102. In other embodiments of the present invention, the degradation platform may be a chain, blade, drill bit, or other moving part of a mining, trenching or road milling machine that may cause picks to engage and degrade formations of various types.

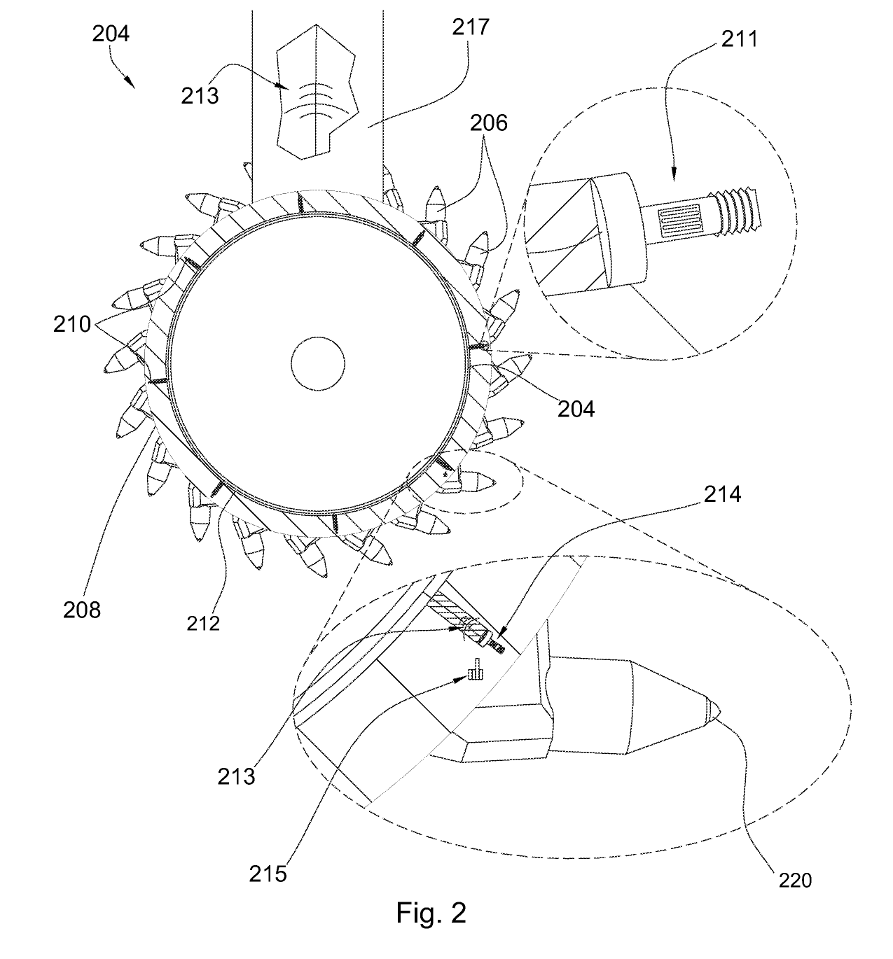

FIG. 2 discloses a cross-sectional view of a degradation drum 204 comprising a plurality of picks 206 mounted on an outside surface 208 and configured to degrade a formation. The degradation drum 204 may be hollow to minimize its overall weight. The degradation drum 204 may also be filled with water, antifreeze, or the like.

A plurality of sensors 210 may be disposed around a perimeter of the degradation drum 204 and inward of the outside surface 208. Each sensor of the plurality of sensors 210 may be disposed such that it can measure impacts on at least one of the plurality of picks 206. The picks 206 may each comprise a hard tip 220 configured to encounter high impacts as it breaks up hard surface formations. On occasion, one of the plurality of picks 206 may become damaged and/or dislocated from its position on the degradation drum 204. Damage to at least one of the picks 206 may cause abnormal stress and wear to other components of the degradation drum 204 leading to a shorter lifetime for all parts. A damaged pick may also be difficult to identify among the plurality of picks 206 disposed on the degradation drum 204. It is an object of the current invention for the plurality of sensors 210 to be configured to detect a damaged pick and determine the damaged pick's location on the degradation drum 204.

The plurality of sensors 210 may be selected from a group consisting of strain gauges, accelerometers, acoustic sensors, and combinations thereof. In the case of the sensors being strain gauges, they may be selected from a group consisting of uniaxial strain gauges, triaxial rosettes, and combinations thereof In the current embodiment, the plurality of sensors 210 are uniaxial strain gauges 211 configured to measure the strain on the picks 206 as forces from a formation are applied to the plurality of picks 206. The uniaxial strain gauges 211 may comprise a thread form which may allow the uniaxial strain gauges 211 to be rotated into a cavity on the outside surface 208.

The plurality of sensors 210 may be connected by a wire 212 disposed within the degradation drum 204. The wire 212 in the embodiment shown is a single armored coaxial wire. The wire 212 may connect the plurality of sensors 210 with a processor (not shown). In the present embodiment, the wire 212 connects the plurality of sensors 210 in a bus network and runs to the processor through an arm 217 rigidly attached to the drum 204. The sensors 210 may be configured to communicate with the processor through the wire 212 by a unique identifier signal 213. The sensors 210 may each comprise a unique identifier which may set the sensor apart from the rest of the sensors in the plurality. From the unique identifier signal 213 the processor may recognize from which sensor the signal is sent. In the embodiment shown, a sensor 214 comprises a unique identifier 215. The sensor 214 may communicate with the processor by sending the unique identifier signal 213 that corresponds to the unique identifier 215.

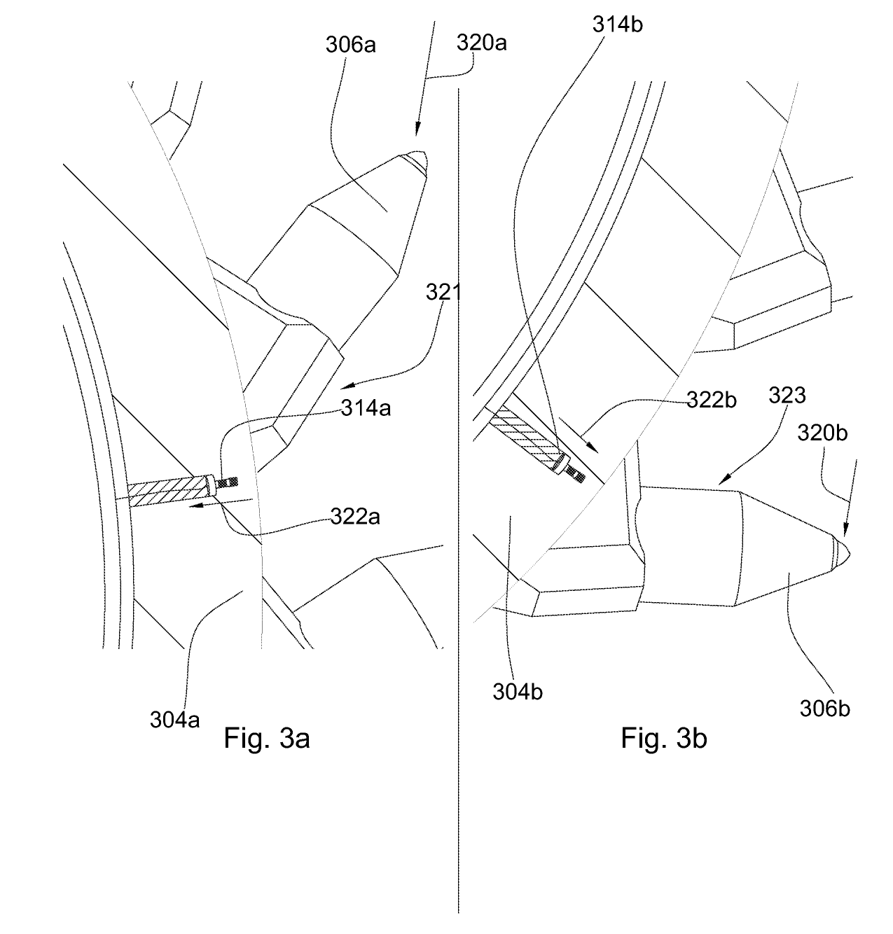

FIGS. 3a and 3b each disclose cross-sectional views of a pick and a sensor being acted on by a force, represented by an arrow 322a and 322b respectively. FIG. 3a discloses a sensor 314a disposed underneath a back side 321 of a pick 306a. As a force, represented by arrow 320a, acts on the pick 306a, the pick's back side 321 is forced into a degradation drum 304a as represented by the arrow 322a. As the pick's back side 321 is forced into the degradation drum 304a, the sensor 314a is in compression. The amount of force acting on the pick 306a may be proportional to the amount of compression detected by the sensor 314a which may allow the sensor 314a to determine how much force is acting on the pick 306a.

FIG. 3b discloses a sensor 314b disposed underneath the front side 323 of a pick 306b. As a force, represented by arrow 320b, acts on pick 306b, the pick's front side 323 is forced away from a degradation drum 304b as represented by the arrow 322b. As the pick's front side 323 is forced away from the degradation drum 304b, the sensor 314b is in tension. The amount of force acting on the pick 306b may be proportional to the amount of tension detected by the sensor 314b which may allow the sensor 314b to determine how much force is acting on the pick 306b.

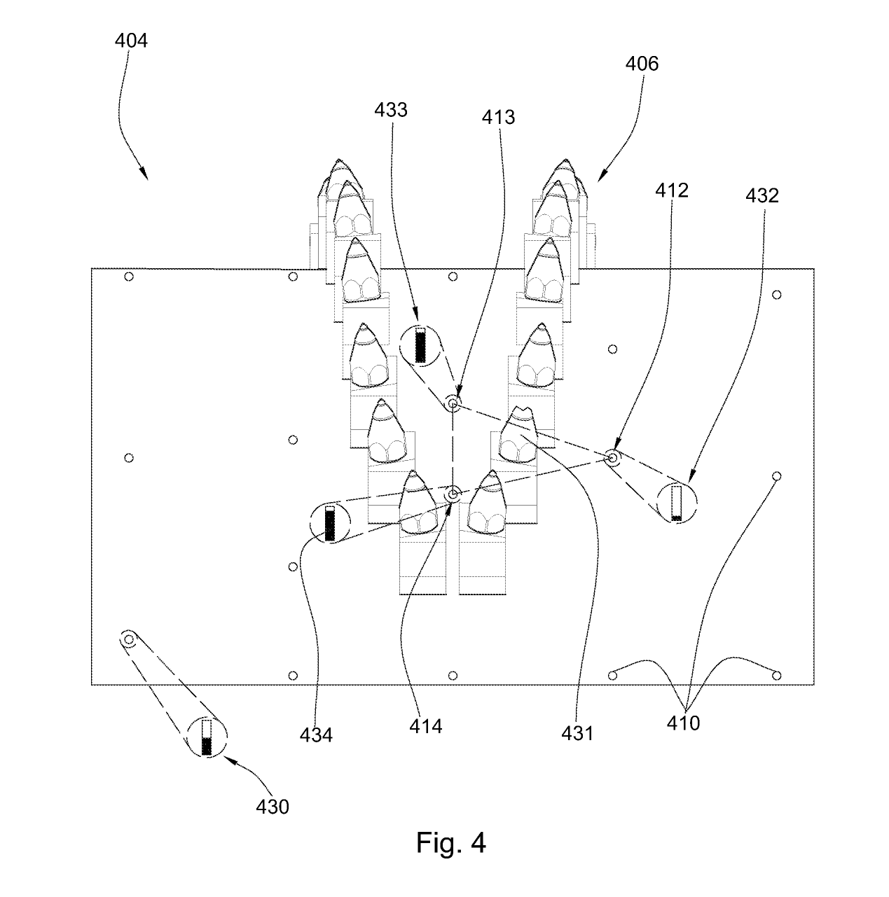

FIG. 4 discloses a degradation platform comprising a degradation drum 404 with a plurality of picks 406 mounted on an outer surface of the degradation drum 404. (A portion of the plurality of picks 406 has been removed for clarity) A plurality of sensors 410 may be disposed within the degradation drum 404 and be configured in at least one circular array around a perimeter of the degradation drum 404. Multiple circular arrays may allow the plurality of sensors 410 to be disposed in a matrix defined by columns and rows which may allow the location of an individual sensor 412, 413, or 414 to be easily established. By knowing the location of a sensor 412, 413, or 414, the location of a selected pick may be more accurately determined.

During regular operation, the plurality of sensors 410 may determine a baseline level detection reading 430. The baseline detection reading 430 may be considered normal for correctly-working unworn picks. There may be instances during operation that the plurality of sensors 410 provide detection readings other than the baseline detection reading 430, for example if a pick becomes worn, damaged or dislocated.

In the present embodiment, a selected pick 431 is damaged. A sensor 412 is disposed adjacent to the selected pick 431 and may provide a detection reading 432. The detection reading 432 may indicate a low stress detection reading due to substantially less force acting on the selected pick 431. Sensors 413 and 414 are disposed adjacent to picks in the vicinity of the selected pick 431 and may provide detection readings 433 and 434 respectively. The detection readings 433 and 434 may exhibit high stress detection readings due to an increased amount of forces acting on the nearby picks that attempt to compensate for the selected pick 431. The low and high detection readings as indicated in the detection readings 432, 433 and 434 may be sent to a processor (not shown) where the information may be used to detect the selected pick 431 and determine its location on the degradation drum 404.

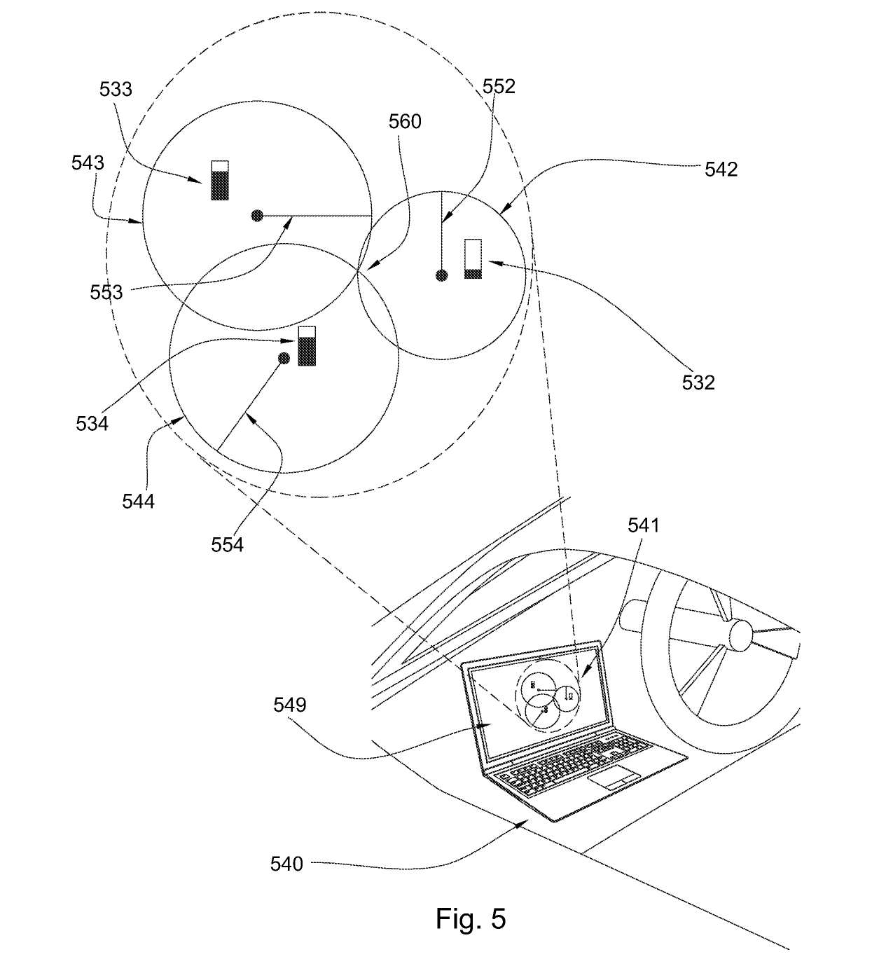

FIG. 5 discloses an embodiment of a processor 540. As shown in the current embodiment, the processor 540 may be housed in a computer or other device that receives data and which may comprise a visual interface 549 configured to display at least one signal 541 for an operator in real time. The processor 540 may be disposed on or off site, and as shown, it may be disposed within the milling machine or other vehicle.

A method for detecting and determining a location of a selected pick may comprise measuring a first reading by an adjacent sensor and measuring dissimilar readings by sensors in the vicinity. For example, the signal 541 which may be displayed on the visual interface 549 may show a low detection reading 532 and high detection readings 533 and 534.

Another method for detecting and determining a location of a selected pick may comprise measuring three readings by three sensors, calculating three distances from each of the three sensors based on magnitudes of the three readings and finding the union of the three distances. For example, a first circle 542 comprising a first radius 552 may correspond to a low detection reading 532. The length of the first radius 552 may be correlated with the magnitude of the first detection reading 532. A second circle 543 comprising a second radius 553 and a third circle 544 comprising a third radius 554 may correspond to second and third detection readings 533 and 534 respectively, and the lengths of the second and third radii 553 and 554 may be correlated with the magnitude of the second and third detection readings 533 and 534. The first, second, and third circles 542, 543, and 544, may intersect at an intersection point 560. The intersection point 560 may correspond to the location of the damaged pick on the milling drum. In some embodiments, the at least three circles may not intersect at an exact point but may form in area which is inside each of the at least three circles. The area, called a union, may correspond to an area on the milling drum in which the damaged pick is located.

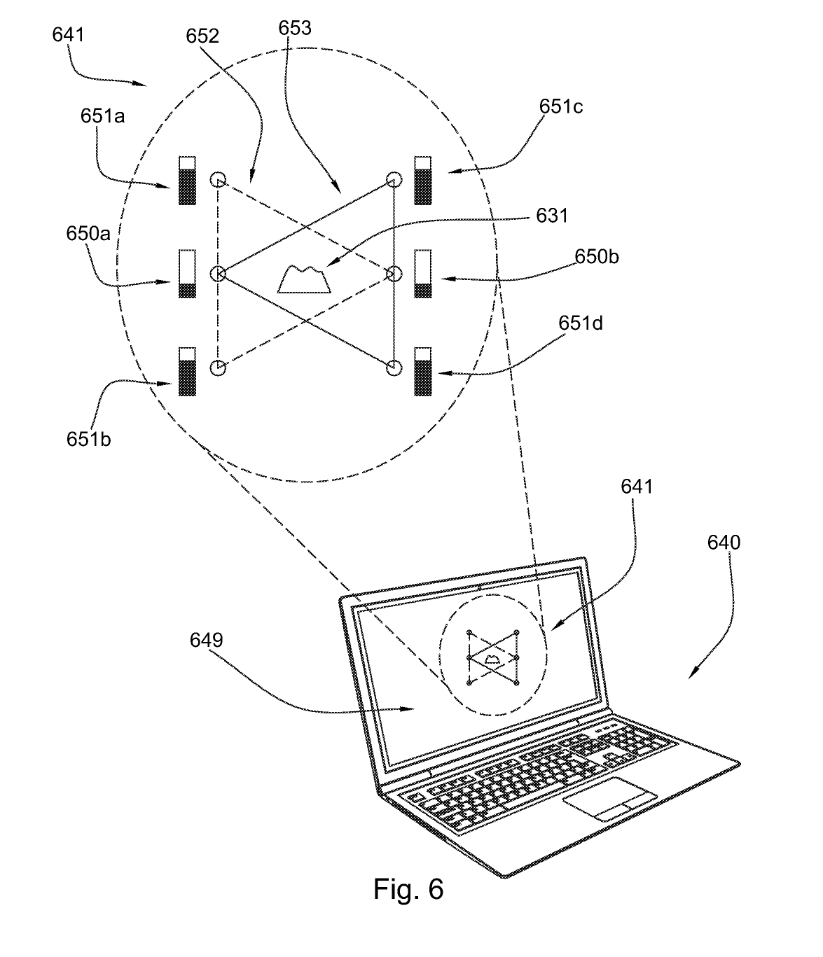

FIG. 6 discloses another embodiment of a processor 640 housed in a computer comprising a visual interface 649 configured to display a signal 641 from a plurality of sensors disposed within a degradation platform. A method for detecting and determining a location of a selected pick may comprise forming at least two triangles and determining the location of the selected pick by the union of the at least two triangles. For example, the signal 641 may display first detection readings from sensors disposed adjacent to a selected pick 631 which may be a damaged pick. In the embodiment shown, the first detection readings are low detection readings 650a and 650b. The signal 641 may also display second detection readings from sensors disposed in the vicinity of the selected pick 631. In the embodiment shown, the second detection readings are high detection readings 651a, 651b, 651c, and 651d. The high detection readings 651a and 651b and the low stress detection reading 650b may form a first triangle 652. The high detection readings 651c and 651d and the low detection reading 650a may form a second triangle 653. Other triangles may be formed from additional detection readings. The location of the selected pick 631 may be determined by the intersection of the at least two triangles 652 and 653.

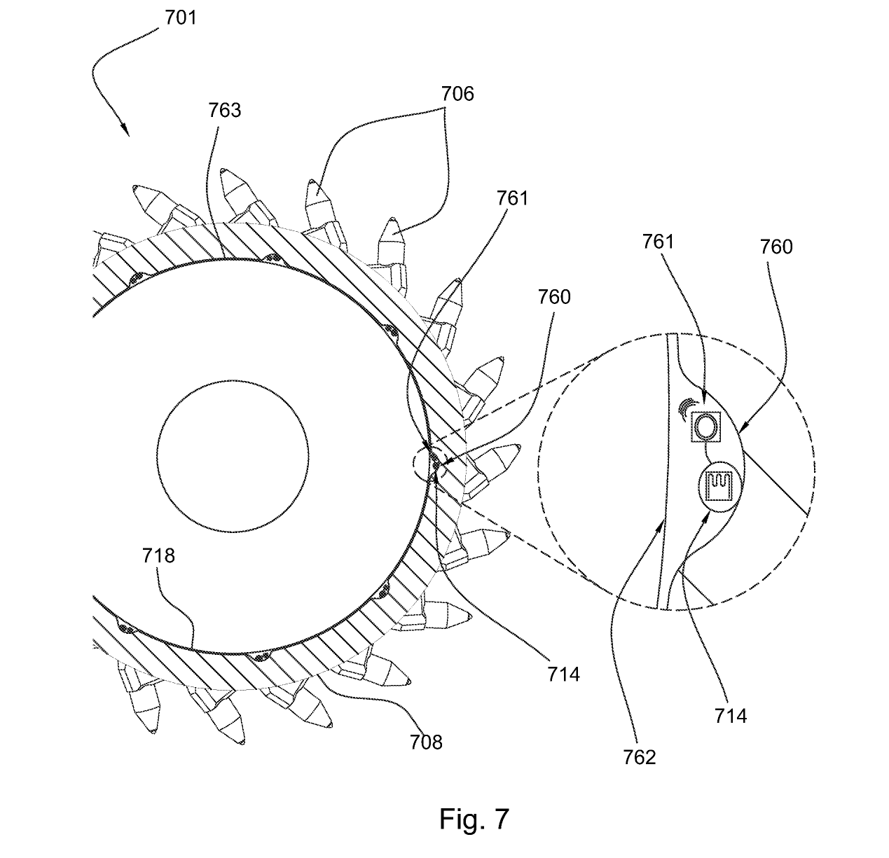

FIG. 7 discloses a cross-sectional view of another embodiment of a milling drum 701 comprising a plurality of picks 706 mounted on an outside surface 708. A second internal surface 718 of the milling drum 701 may comprise at least one cavity 760.

The cavity 760 may be configured to house at least one sensor 714. The sensor 714 in the current embodiment is a uniaxial strain gauge that may be bonded to the second internal surface 718. The sensor 714 may be connected to a transmitter 761 that is configured to communicate with a processor (not shown) via a wireless communication.

Due to the sensor 714 being disposed within the cavity 760, a coating 762 may overlay the second internal surface 718. The coating 762 may comprise an epoxy or other type of resin that is configured to protect the sensor 714 and transmitter 761.

The cavity 760 may also provide compliancy for the sensor 714. The compliancy may be advantageous in allowing the sensor 714 to more easily detect the forces acting on the picks 706.

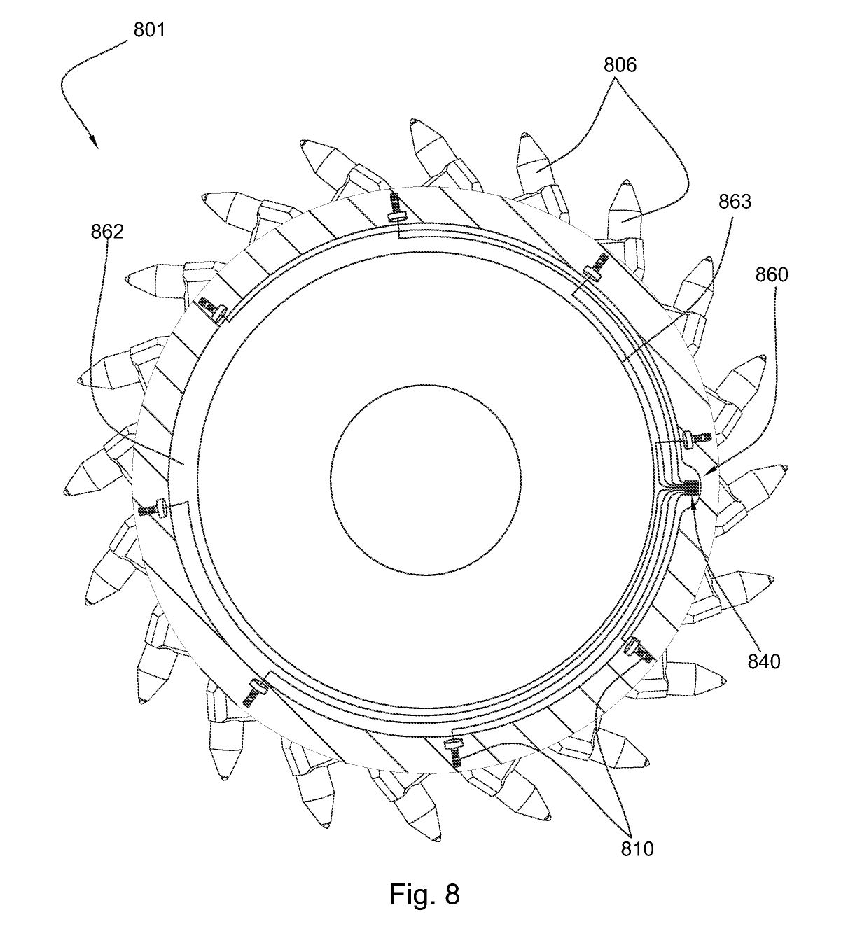

FIG. 8 discloses a cross-sectional view of another embodiment of a milling drum 801 comprising a cavity 860 disposed on an internal surface 863. The cavity 860 may house a processor 840. A plurality of sensors 810 disposed within the internal surface 863 of the milling drum 801 may each connect with the processor 840 individually with a wire, and a coating 862 may overlay the internal surface 863 to protect the processor 840 and wires. In the embodiment shown, the sensors 810 are triaxial rosette strain gauges. These strain gauges may be configured to measure forces acting on a plurality of picks 806 in three different directions, along x, y, and z axes. During normal drilling operation, the processor 840 may be configured to store data received from the plurality of sensors 810. Data from the sensors 810 may be extracted from the processor 840 when not in operation.

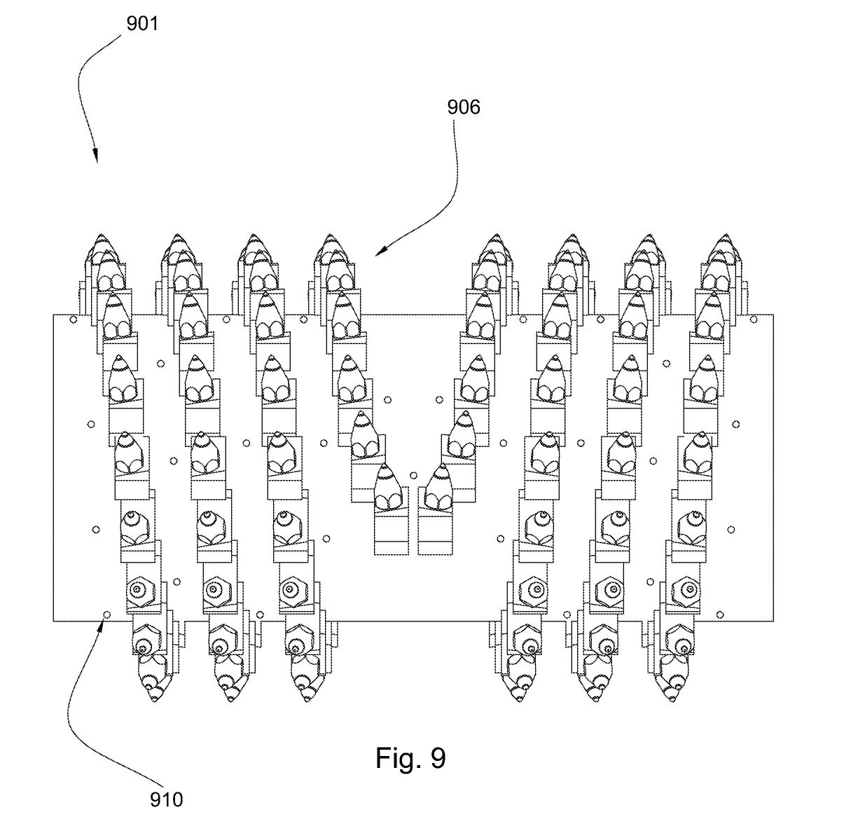

FIG. 9 discloses an orthogonal view of an embodiment of a milling drum 901 comprising a plurality of picks 906 and a plurality of sensors 910. The picks 906 may be configured to maximize the effectiveness of degrading a formation and the sensors 910 may be disposed in a configuration substantially parallel to the configuration of the picks 906. It is believed that disposing the sensors 910 in parallel configuration to the picks 906 may allow the sensors 910 to better determine the location of a selected pick.

Whereas the present invention has been described in particular relation to the drawings attached hereto, it should be understood that other and further modifications apart from those shown or suggested herein, may be made within the scope and spirit of the present invention.

What is claimed is:

1. A degradation assembly, comprising:
a platform comprising a surface;
a plurality of picks each comprising a hard tip and a shank mounted on the surface; and
a plurality of sensors disposed within the platform such that they can measure impacts on at least one of the picks;
wherein the sensors are in communication with a processor.

2. The assembly of claim 1, wherein each of the plurality of sensors corresponds with one of the plurality of picks.

3. The assembly of claim 1, wherein the plurality of sensors are selected from a group consisting of strain gauges, accelerometers, acoustic sensors, and combinations thereof

4. The assembly of claim 3, wherein the strain gauges are selected from a group consisting of uniaxial strain gauges, triaxial rosettes, and combinations thereof.

5. The assembly of claim 1, wherein the platform is a drum, a chain, a blade, or a drill bit.

6. The assembly of claim 5, wherein the platform is a drum and the plurality of sensors are disposed around a perimeter of the drum.

7. The assembly of claim 1, wherein at least one sensor of the plurality of sensors is disposed in a cavity on the surface.

8. The assembly of claim 1, wherein the platform further comprises a second internal surface and at least one sensor of the plurality of sensors is disposed in a cavity on the second internal surface.

9. The assembly of claim 1, wherein at least one sensor of the plurality of sensors is disposed inward of the surface.

10. The assembly of claim 1, wherein at least one sensor of the plurality of sensors is disposed inward of at least one pick of the plurality of picks.

11. The assembly of claim 1, wherein the plurality of sensors each comprise a unique identifier signal for communication with the processor.

12. The assembly of claim 1, wherein the processor is in communication with a visual interface.

13. The assembly of claim 1, wherein the processor is disposed within the platform and stores data received from the plurality of sensors.

14. The assembly of claim 1, wherein the plurality of sensors comprise at least one wireless communication device for communication with the processor.

15. The assembly of claim 1, wherein the plurality of sensors are disposed in at least one circular array.

16. The assembly of claim 1, wherein the plurality of sensors is disposed in a configuration substantially parallel to a configuration of the plurality of picks.

17. A method of detecting and determining a location of a selected pick, comprising:
mounting a plurality of picks on a surface of a platform and a plurality of sensors within the platform;
measuring impacts on at least one of the picks with at least one of the sensors;
detecting a variation on the at least one pick with the at least one sensor; and
determining a location of the at least one pick with more than one of the sensors.

18. The method of claim 17, wherein detecting the variation comprises measuring a first reading by the at least one sensor and determining the location comprises measuring dissimilar readings by adjacent sensors.

19. The method of claim 17, wherein the determining the location comprises measuring three readings by three sensors, calculating three distances from each of the three sensors based on magnitudes of the three readings and finding the union of the three distances.

20. The method of claim 17, wherein the determining the location comprises forming at least two triangles and determining the location of the selected pick by the union of the at least two triangles.
